(19) United States
(12) Patent Application Publication
(10) Pub. No.: US 2023/0341248 A1
(43) Pub. Date: Oct. 26, 2023

(54) USING A STIFFNESS MEASUREMENT TO COMPENSATE A FLUID PROPERTY MEASUREMENT

(71) Applicant: MICRO MOTION, INC., Boulder, CO (US)

(72) Inventor: Frederick Scott SCHOLLENBERGER, Oakland, CA (US)

(73) Assignee: MICRO MOTION, INC., Boulder, CO (US)

(21) Appl. No.: 18/002,351

(22) PCT Filed: Jul. 14, 2020
(86) PCT No.: PCT/US2020/041888

§ 371 Date: Dec. 19, 2022

(51) Int. Cl. G01F 1/84; G01N 9/00

(52) U.S. Cl. CPC G01F 1/8436; G01N 9/002; G01N 2009/006

(57) ABSTRACT

A meter electronics (20) for using a stiffness measurement to compensate a fluid property measurement is provided. The meter electronics (20) comprises an interface (601) configured to communicatively couple to a sensor assembly (10) and receive sensor signals from the sensor assembly (10), and a processing system (602) communicatively coupled to the interface (601). The processing system (602) is configured to determine a fluid property value based on the sensor signals and correct the fluid property value with a fluid property correction value, the fluid property correction value being correlated with a current stiffness value of the sensor assembly.

### TECHNICAL FIELD

The embodiments described below relate to fluid property measurements and, more particularly, to using stiffness to compensate a fluid property measurement.

### BACKGROUND

Vibratory meters, such as for example, Coriolis mass flowmeters, liquid density meters, gas density meters, liquid viscosity meters, gas/liquid specific gravity meters, gas/liquid relative density meters, and gas molecular weight meters, are generally known and are used for measuring characteristics of fluids. Generally, vibratory meters comprise a sensor assembly and a meter electronics. The material within the sensor assembly may be flowing or stationary. The vibratory meter may be used to measure a mass flow rate, density, or other properties of a material in the sensor assembly.

Material flows into the vibratory meter from a connected pipeline on the inlet side of the vibratory meter, is directed through the measuring conduit(s), and exits the vibratory meter through the outlet side of the vibratory meter. The pipeline may exert a force, called flange loading, on the inlets and outlets of the vibratory meter, which may affect a stiffness of the sensor assembly. During operation, the natural vibration modes of the vibrating system are defined in part by the combined mass of the measuring conduits and the material flowing within the measuring conduits.

When there is no-flow through the vibratory meter, a driving force applied to the measuring conduit(s) causes all points along the measuring conduit(s) to oscillate with identical phase or a small “zero offset”, which is a time delay measured at zero flow. As material begins to flow through the vibratory meter, Coriolis forces cause each point along the measuring conduit(s) to have a different phase. For example, the phase at the inlet end of the vibratory meter lags the phase at the centralized driver position, while the phase at the outlet leads the phase at the centralized driver position. Pickoffs on the measuring conduit(s) produce sinusoidal signals representative of the motion of the measuring conduit(s). Signals output from the pickoffs are processed to determine the time delay between the pickoffs. The time delay between the two or more pickoffs is proportional to the mass flow rate of material flowing through the measuring conduit(s). Meter electronics connected to the driver generate a drive signal to operate the driver and determine a mass flow rate and other properties of a material from signals received from the pickoffs.

The mass flow rate and other properties may be corrected by using temperature measurements, pressure measurements, and/or estimates of a flange loading on the sensor assembly. For example, the mass flow rate may be calculated using a mass flow rate equation where temperature values of the tube, case, and fluid are multiplied with constants, summed and then multiplied with the uncorrected mass flow rate value. However, this requires temperature and pressure sensors and may not account for other conditions, such as flange loading, that can affect the mass flow rate measurement. Similar issues may affect density, as well as other fluid property, measurements. Accordingly, there is a need for using a stiffness measurement to compensate a fluid property measurement.

### SUMMARY

A meter electronics for using a stiffness measurement to compensate a fluid property measurement is provided. According to an embodiment, the meter electronics comprises an interface configured to communicatively couple to a sensor assembly and receive sensor signals from the sensor assembly, and a processing system communicatively coupled to the interface. The processing system is configured to determine a fluid property value based on the sensor signals and correct the fluid property value with a fluid property correction value, the fluid property correction value being correlated with a current stiffness value of the sensor assembly.

A method of using a stiffness measurement to compensate a fluid property measurement is provided. According to an embodiment, the method comprises determining a fluid property value of a fluid based on sensor signals provided by a sensor assembly containing the fluid and correcting the fluid property value with a fluid property correction value, the fluid property correction value being correlated with a current stiffness value of the sensor assembly.

### ASPECTS

According to an aspect, a meter electronics (20) for using a stiffness measurement to compensate a fluid property measurement comprising an interface (601) configured to communicatively couple to a sensor assembly (10) and receive sensor signals from the sensor assembly (10), and a processing system (602) communicatively coupled to the interface (601). The processing system (602) is configured to determine a fluid property value based on the sensor signals and correct the fluid property value with a fluid property correction value, the fluid property correction value being correlated with a current stiffness value of the sensor assembly.

Preferably, the processing system (602) is further configured to determine the current stiffness value of the sensor assembly (10).

Preferably, the processing system (602) is further configured to use a previously determined stiffness value of the sensor assembly to correlate the current stiffness value with the fluid property correction value.

Preferably, the previously determined stiffness value is correlated with the fluid property correction value.

Preferably, the previously determined stiffness value is correlated with the fluid property correction value by using at least one of an empirical analysis and a computer model of the sensor assembly.

Preferably, the fluid property correction value is correlated with the current stiffness value by using a previously determined stiffness-to-fluid property relationship.

Preferably, the fluid property value is one of a mass flow rate value, a density value, a time delay value, a phase difference value, a resonance frequency value, and an oscillation period value.

Preferably, the fluid property correction value is a percentage error value.

Preferably, the current stiffness value is part of a mode relationship, the mode relationship being a relationship between characteristics of two vibration modes.

According to an aspect, a method of using a stiffness measurement to compensate a fluid property measurement comprises determining a fluid property value of a fluid based on sensor signals provided by a sensor assembly containing the fluid, and correcting the fluid property value with a fluid property correction value, the fluid property correction value being correlated with a current stiffness value of the sensor assembly.

Preferably, the method further comprises determining the current stiffness value of the sensor assembly.

Preferably, the method further comprises using a previously determined stiffness value of the sensor assembly to correlate the current stiffness value with the fluid property correction value.

Preferably, the previously determined stiffness value is correlated with the fluid property correction value.

Preferably, the previously determined stiffness value is correlated with the fluid property correction value by using at least one of an empirical analysis and a computer model of the sensor assembly.

Preferably, the method further comprises correlating the fluid property correction value with the current stiffness value by using a previously determined stiffness-to-fluid property relationship.

Preferably, the fluid property value is one of a mass flow rate value, a density value, a time delay value, a phase difference value, a resonance frequency value, and an oscillation period value.

Preferably, the fluid property correction value is a percentage error value.

Preferably, the current stiffness value is part of a mode relationship, the mode relationship being a relationship between characteristics of two vibration modes.

### BRIEF DESCRIPTION OF THE DRAWINGS

The same reference number represents the same element on all drawings. It should be understood that the drawings are not necessarily to scale.

FIG. 1 shows a vibratory meter 5 for using a stiffness measurement to compensate the fluid property measurement.

FIG. 2 shows a block diagram of the vibratory meter 5, including a block diagram representation of the meter electronics 20.

FIG. 3 shows a block diagram of the vibratory meter 5 with notch filters according to an embodiment.

FIGS. 4A and 4B show wireline diagrams of conduits to illustrate vibration modes of the conduits, such as the conduits 130, 130′ described above.

FIGS. 5A and 5B show graphs illustrating correlations between error values and stiffness values.

FIG. 6 shows the meter electronics 20 for compensating a fluid property measurement.

FIG. 7 shows a method 700 for using a stiffness measurement to compensate a fluid property measurement.

### DETAILED DESCRIPTION

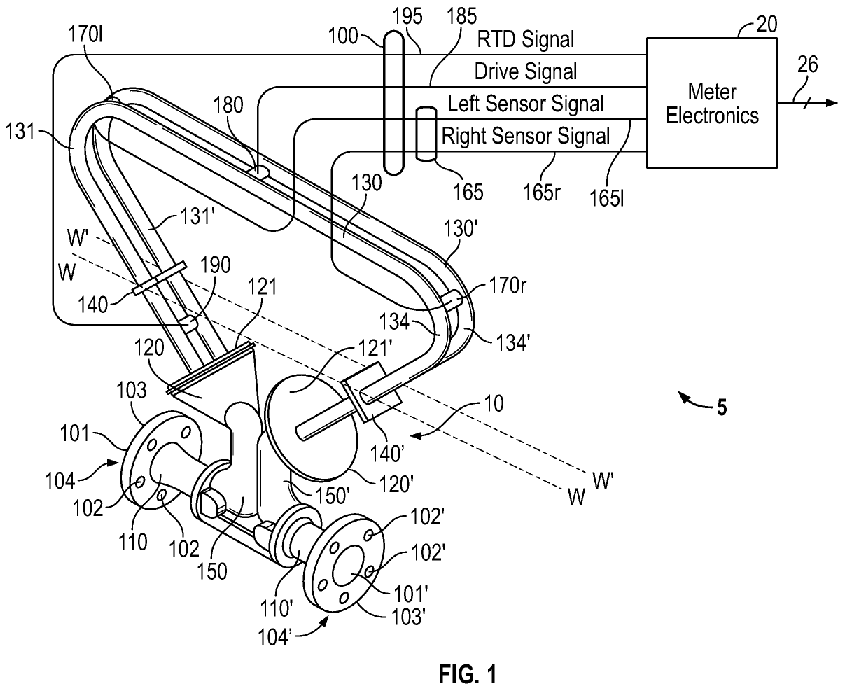

FIGS. 1-7 and the following description depict specific examples to teach those skilled in the art how to make and use the best mode of embodiments of using a stiffness measurement to compensate a fluid property measurement. For the purpose of teaching inventive principles, some conventional aspects have been simplified or omitted. Those skilled in the art will appreciate variations from these examples that fall within the scope of the present description. Those skilled in the art will appreciate that the features described below can be combined in various ways to form multiple variations of using the stiffness measurement to compensate the fluid property measurement. As a result, the embodiments described below are not limited to the specific examples described below, but only by the claims and their equivalents.

FIG. 1 shows a vibratory meter 5 for using a stiffness measurement to compensate the fluid property measurement. As shown in FIG. 1, the vibratory meter 5 comprises a sensor assembly 10 and meter electronics 20. The sensor assembly 10 responds to mass flow rate and density of a process material. The meter electronics 20 is connected to the sensor assembly 10 via leads 100 to provide density, mass flow rate, and temperature information over port 26, as well as other information.

The sensor assembly 10 includes a pair of manifolds 150 and 150′, flanges 103 and 103′ having flange necks 110 and 110′, a pair of parallel conduits 130 and 130′, driver 180, resistive temperature detector (RTD) 190, and a pair of pick-off sensors 1701 and 170r. Conduits 130 and 130′ have two essentially straight inlet legs 131, 131′ and outlet legs 134, 134′, which converge towards each other at conduit mounting blocks 120 and 120′. The conduits 130, 130′ bend at two symmetrical locations along their length and are essentially parallel throughout their length. Brace bars 140 and 140′ serve to define the axis W and W′ about which each conduit 130, 130′ oscillates. The legs 131, 131′ and 134, 134′ of the conduits 130, 130′ are fixedly attached to conduit mounting blocks 120 and 120′ and these blocks, in turn, are fixedly attached to manifolds 150 and 150′. This provides a continuous closed material path through sensor assembly 10.

When flanges 103 and 103′, having holes 102 and 102′ are connected, via inlet end 104 and outlet end 104′ into a process line (not shown) which carries the process material that is being measured, material enters inlet end 104 of the meter through an orifice 101 in the flange 103 and is conducted through the manifold 150 to the conduit mounting block 120 having a surface 121. Within the manifold 150 the material is divided and routed through the conduits 130, 130′. Upon exiting the conduits 130, 130′, the process material is recombined in a single stream within the block 120′ having a surface 121′ and the manifold 150′ and is thereafter routed to outlet end 104′ connected by the flange 103′ having holes 102′ to the process line (not shown).

The conduits 130, 130′ are selected and appropriately mounted to the conduit mounting blocks 120, 120′ so as to have substantially the same mass distribution, moments of inertia and Young's modulus about bending axes W-W and W′-W′, respectively. These bending axes go through the brace bars 140, 140′. Inasmuch as the Young's modulus of the conduits change with temperature, and this change affects the calculation of flow and density, RTD 190 is mounted to conduit 130′ to continuously measure the temperature of the conduit 130′. The temperature of the conduit 130′ and hence the voltage appearing across the RTD 190 for a given current passing therethrough is governed by the temperature of the material passing through the conduit 130′. The temperature dependent voltage appearing across the RTD 190 is used in a well-known method by the meter electronics 20 to compensate for the change in elastic modulus of the conduits 130, 130′ due to any changes in conduit temperature. The RTD 190 is connected to the meter electronics 20 by the lead carrying the RTD signal 195.

Both of the conduits 130, 130′ are driven by driver 180 in opposite directions about their respective bending axes W and W′ and at what is termed the first out-of-phase bending mode of the flow meter. This driver 180 may comprise any one of many well-known arrangements, such as a magnet mounted to the conduit 130′ and an opposing coil mounted to the conduit 130 and through which an alternating current is passed for vibrating both conduits 130, 130′. A suitable drive signal 185 is applied by the meter electronics 20, via a lead, to the driver 180.

The meter electronics 20 receives the RTD signal 195 on a lead, and sensor signals 165 appearing on leads 100 carrying left and right sensor signals 1651, 165r, respectively. The meter electronics 20 produces the drive signal 185 appearing on the lead to driver 180 and vibrate conduits 130, 130′. The meter electronics 20 processes the left and right sensor signals 1651, 165r and the RTD signal 195 to compute the mass flow rate and the density of the material passing through sensor assembly 10. This information, along with other information, is applied by meter electronics 20 over path 26 as a signal. A more detailed discussion of the meter electronics 20 follows.

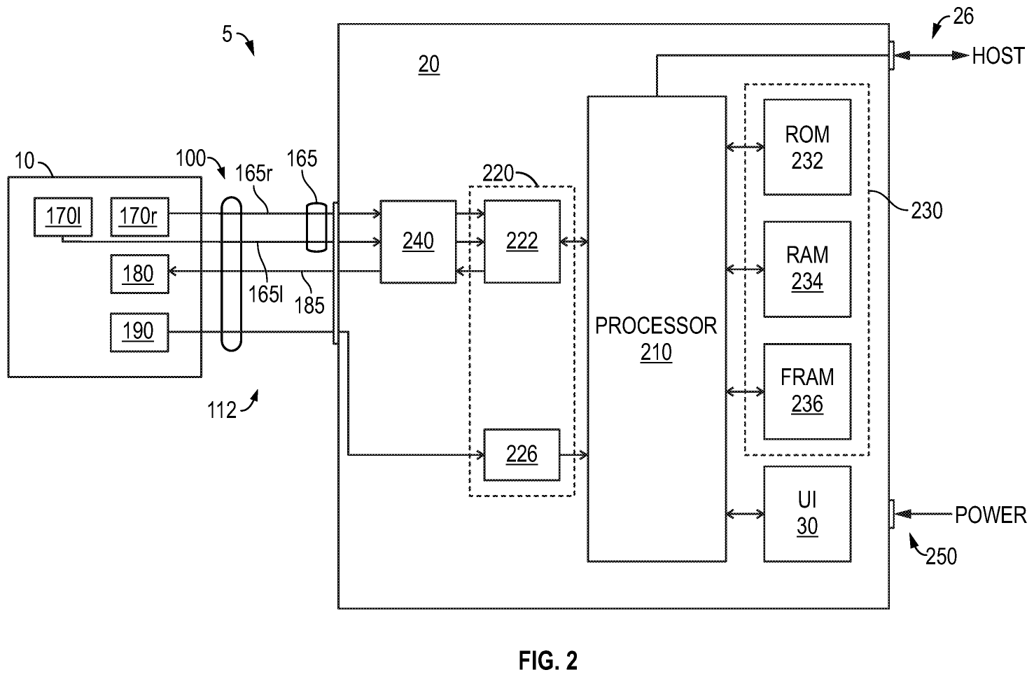

FIG. 2 shows a block diagram of the vibratory meter 5, including a block diagram representation of the meter electronics 20. As shown in FIG. 2, the meter electronics 20 is communicatively coupled to the sensor assembly 10. As described in the foregoing with reference to FIG. 1, the sensor assembly 10 includes the left and right pick-off sensors 1701, 170r, driver 180, and RTD 190, which are communicatively coupled to the meter electronics 20 via the set of leads 100 through a communications channel 112.

The meter electronics 20 provides a drive signal 185 via the leads 100. More specifically, the meter electronics 20 provides a drive signal 185 to the driver 180 in the sensor assembly 10. In addition, sensor signals 165 comprising the left sensor signal 1651 and the right sensor signal 165r are provided by the sensor assembly 10. More specifically, in the embodiment shown, the sensor signals 165 are provided by the left and right pick-off sensor 1701, 170r in the sensor assembly 10. As can be appreciated, the sensor signals 165 are respectively provided to the meter electronics 20 through the communications channel 112.

The meter electronics 20 includes a processor 210 communicatively coupled to one or more signal processors 220 and one or more memories 230. The processor 210 is also communicatively coupled to a user interface 30. The processor 210 is communicatively coupled with the host via a communication port over the port 26 and receives electrical power via an electrical power port 250. The processor 210 may be a microprocessor although any suitable processor may be employed. For example, the processor 210 may be comprised of sub-processors, such as a multi-core processor, serial communication ports, peripheral interfaces (e.g., serial peripheral interface), on-chip memory, I/O ports, and/or the like. In these and other embodiments, the processor 210 is configured to perform operations on received and processed signals, such as digitized signals.

The processor 210 may receive digitized sensor signals from the one or more signal processors 220. The processor 210 is also configured to provide information, such as a phase difference, a property of a fluid in the sensor assembly 10, or the like. The processor 210 may provide the information to the host through the communication port. The processor 210 may also be configured to communicate with the one or more memories 230 to receive and/or store information in the one or more memories 230. For example, the processor 210 may receive calibration factors and/or sensor assembly zeros (e.g., phase difference when there is zero flow) from the one or more memories 230. Each of the calibration factors and/or sensor assembly zeros may respectively be associated with the vibratory meter 5 and/or the sensor assembly 10. The processor 210 may use the calibration factors to process digitized sensor signals received from the one or more signal processors 220.

The one or more signal processors 220 is shown as being comprised of an encoder/decoder (CODEC) 222 and an analog-to-digital converter (ADC) 226. The one or more signal processors 220 may condition analog signals, digitize the conditioned analog signals, and/or provide the digitized signals. The CODEC 222 is configured to receive the sensor signals 165 from the left and right pick-off sensors 1701, 170r. The CODEC 222 is also configured to provide the drive signal 185 to the driver 180. In alternative embodiments, more or fewer signal processors may be employed.

As shown, the sensor signals 165 are provided to the CODEC 222 via a signal conditioner 240. The drive signal 185 is provided to the driver 180 via the signal conditioner 240. Although the signal conditioner 240 is shown as a single block, the signal conditioner 240 may be comprised of signal conditioning components, such as two or more op-amps, filters, such as low pass filters, voltage-to-current amplifiers, or the like. For example, the sensor signals 165 may be amplified by a first amplifier and the drive signal 185 may be amplified by the voltage-to-current amplifier. The amplification can ensure that the magnitude of the sensor signals 165 is approximate the full-scale range of the CODEC 222.

In the embodiment shown, the one or more memories 230 is comprised of a read-only memory (ROM) 232, random access memory (RAM) 234, and a ferroelectric random-access memory (FRAM) 236. However, in alternative embodiments, the one or more memories 230 may be comprised of more or fewer memories. Additionally, or alternatively, the one or more memories 230 may be comprised of different types of memory (e.g., volatile, non-volatile, etc.). For example, a different type of non-volatile memory, such as, for example, erasable programmable read only memory (EPROM), or the like, may be employed instead of the FRAM 236. The one or more memories 230 may be a storage configured to store process data, such as drive or sensor signals, mass flow rate or density measurements, etc.

A mass flow rate \dot{m} value can be determined according to the equation:

\dot{m}=FCF[Δt−Δt₀] [1]

The time delay Δt term comprises an operationally-derived (i.e., measured) time delay value comprising the time delay existing between the pickoff sensor signals, such as where the time delay is due to Coriolis effects related to mass flow rate through the vibratory meter 5. A time delay Δt measurement ultimately determines the mass flow rate \dot{m} value of the flow material as it flows through the vibratory meter 5. The zero flow Δt₀ term comprises a time delay/phase difference at zero flow calibration constant. The zero flow Δt₀ term is typically determined at the factory and programmed into the vibratory meter 5. The time delay/phase difference at zero flow Δt₀ term may not change, even where flow conditions are changing, unless a change occurs in the sensor assembly. A mass flow rate of material flowing through the vibratory meter is determined by multiplying a measured time delay (or phase difference/frequency) by the flow calibration factor FCF. The flow calibration factor FCF is proportional to a physical stiffness of the flow meter.

As to a density measurement p, a resonance frequency at which each conduit 130, 130′ will vibrate may be a function of the square root of a spring constant of the conduit 130, 130′ divided by the total mass of the conduit 130, 130′ having a material. The total mass of the conduit 130, 130′ having the material may be a mass of the conduit 130, 130′ plus a mass of a material inside the conduit 130, 130′. The mass of the material in the conduit 130, 130′ is directly proportional to the density of the material. Therefore, the density of this material may be proportional to the square of a period at which the conduit 130, 130′ containing the material oscillates multiplied by the spring constant of the conduit 130, 130′. Hence, by determining the period at which the conduit 130, 130′ oscillates, referred to herein as an oscillation period, and by appropriately scaling the result, an accurate measurement of the density of the material contained by the conduit 130, 130′ can be obtained. The meter electronics 20 can determine the period or resonance frequency using the sensor signals 165 and/or the drive signal 185. The conduits 130, 130′ may oscillate with more than one vibration mode.

Due to changes in stiffness of the conduits, such as the conduits 130, 130′ described above, a mass flow rate \dot{m} measurement and a density ρ measurement may vary over time even if the mass flow rate \dot{m} and density ρ of the material remains constant. For example, if a temperature of the conduits increases, then the conduits' stiffness may correspondingly increase. This increase in stiffness may change the time delay Δt (or phase difference) between the sensor signals provided by the left and right pickoff sensors. This increase in stiffness may also change a resonance frequency of the conduits.

As can be appreciated from the above equation [1], the mass flow rate \dot{m} may be more accurately measured by compensating a time delay Δt measurement (or phase difference) between the left and right sensor signals, or by compensating a mass flow rate \dot{m} measurement. Similarly, the density ρ may be more accurately measured compensating a resonance frequency measurement (or an oscillation period value) of, for example, one of the sensor signals, or by compensating a density ρ measurement. Although the foregoing discusses measuring a time delay Δt, phase difference, mass flow rate \dot{m}, resonance frequency, oscillation period, and density, other fluid property measurements, such as, for example, viscosity, flow velocity, etc., may be compensated.

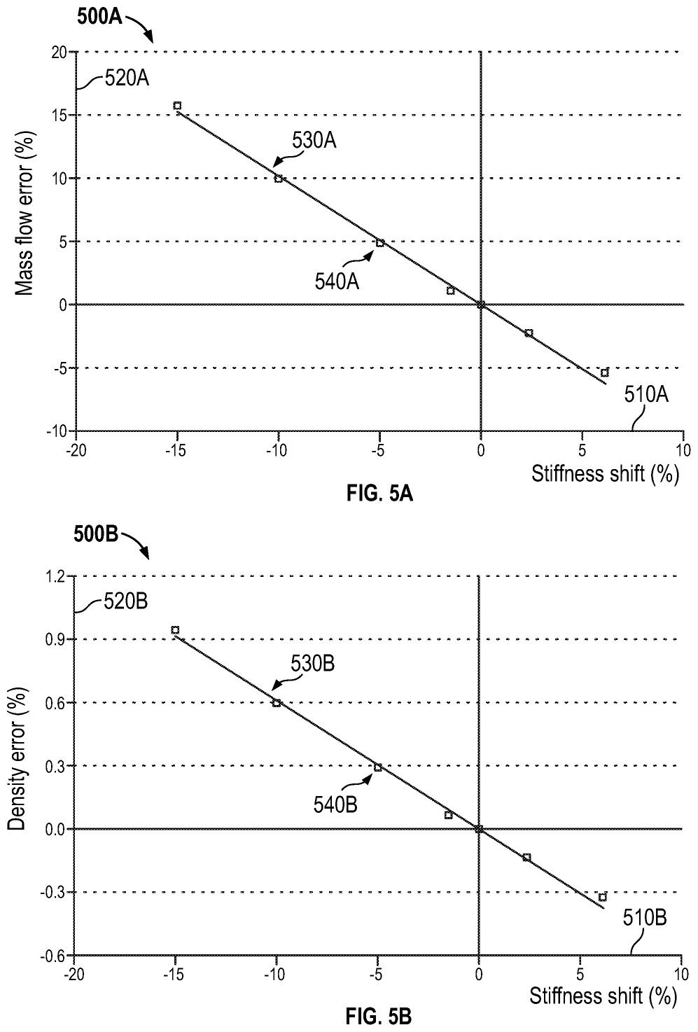

The fluid property measurements may be compensated by measuring a stiffness of the sensor assembly. The stiffness of the sensor assembly may be previously correlated with a fluid property. For example, one or more stiffness values of the sensor assembly, such as conduits of the sensor assembly, may be previously correlated with one or more correction values associated with a fluid property. In a more particular example, as is described in more detail below with reference to FIGS. 5A and 5B, a plurality of stiffness values may be previously correlated with a plurality of mass flow rate \dot{m} error values or density ρ error values. The correlation can be used to compensate a fluid property measurement by determining a current stiffness value of the sensor assembly, which can be determined by any suitable technique.

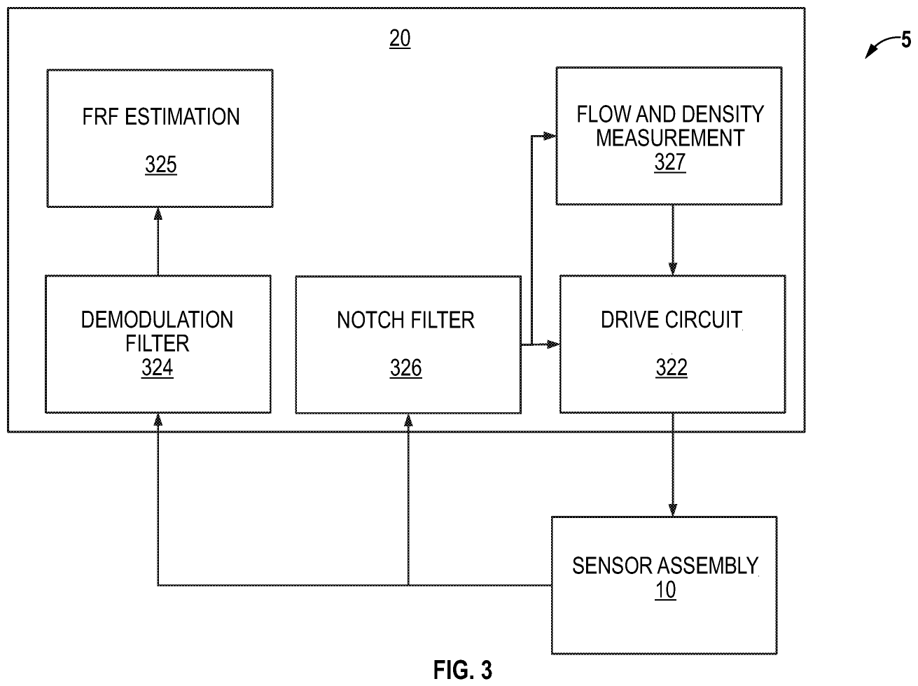

In one exemplary technique, the current stiffness value of the sensor assembly may be determined using the sensor signals that are used to determine a fluid property value. For example, the sensor signals may be used to determine a density value and the current stiffness value as well as a stiffness value. This may be accomplished by providing a drive signal with a resonance frequency component and several non-resonance frequency components. The sensor assembly may vibrate in response to these resonance and non-resonance frequency. Accordingly, the pickoff sensors may provide sensor signals that are comprised of resonance and non-resonance frequency components that respectively correspond to the resonance and non-resonance components of the drive signal. These resonance and non-resonance components can be filtered by a processing system to determine a fluid property value (e.g., density value) and a current stiffness value, as is described in more detail in the following with reference to FIG. 3.

FIG. 3 shows a block diagram of the vibratory meter 5 with notch filters according to an embodiment. As shown in FIG. 2, the vibratory meter 5 includes the sensor assembly 10 and the meter electronics 20 communicatively coupled to the sensor assembly 10. The meter electronics 20 is configured to provide a multi-tone drive signal to the sensor assembly 10. The sensor assembly 10 provides sensor signals to the meter electronics 20. The meter electronics 20 includes a drive circuit 322 and a demodulation filter 324 that are communicatively coupled to the sensor assembly 10. The demodulation filter 324 is communicatively coupled to an FRF estimation unit 325. A notch filter 326 is communicatively coupled to the drive circuit 322 and a flow and density measurement module 327. The notch filter signal is provided to the flow and density measurement module 327 to determine the flow rate and/or density of the fluid in the vibratory meter 5.

The drive circuit 322 receives a resonant component of the sensor signal from the notch filter 326. The drive circuit 322 is configured to generate a multi-tone drive signal for the sensor assembly 10. The multi-tone drive signal is comprised of a drive tone and test tones. The drive tone is based on the resonant component provided by the notch filter 326. For example, the drive circuit 322 may include a feedback circuit that receives the resonant component and generates the drive tone by amplifying the resonant component. Other methods may be employed. The drive circuit 322 can also generate the test tones at predetermined frequencies that are spaced apart from the resonant frequency.

The demodulation filter 324 receives the sensor signal from the sensor assembly 10 and filters out intermodulation distortion signals that may be present in the sensor signal. For example, the drive tone and test tones in the multi-tone drive signal may induce intermodulation distortion signals in the sensor signals provided by the sensor assembly 10. To filter out the intermodulation distortion signals, the demodulation filter 324 may include demodulation windows or passbands that include the frequencies of the drive tone and the test tones. Accordingly, the demodulation filter 324 provides a sensor signal comprised of the resonance components and non-resonance components that correspond to the test tones, while preventing the intermodulation distortion signals from corrupting meter verification of the sensor assembly 10. The meter verification is performed using the FRF estimation unit 325, which compares the components corresponding to the test tones and the test tones to characterize the frequency response of the sensor assembly.

The notch filter 326 is used during meter verification. Accordingly, the notch filter 326 may not be switched in during normal flow and density measurement. Due to fairly large frequency changes in normal operation, coefficients of the notch filter 326 coefficients may need to be frequently calculated and updated, which results in additional computational load and possible unwanted transients. Instead, when meter verification is utilized, the drive tone is sampled to determine the carrier frequency and the coefficients of the notch filter 326 are calculated based on the determined carrier frequency. The notch filter 326 is then switched in and the test tones are ramped to desired amplitude. During meter verification, the carrier frequency may be monitored and if a difference between the determined carrier frequency (determined during the sampling of the drive tone as described above) and the carrier frequency during meter verification is greater than a threshold, then the meter verification may be terminated by, for example, switching out the notch filter 326 and turning off the test tones.

To filter out the sensor signal components, the notch filter 326 includes a plurality of stop bands centered at or about the frequencies of the test tones. The sensor signal components are attenuated or filtered out due to being centered at or about the frequencies of the stop bands. The resonant signal is passed due to being in the pass band of the notch filter 326. However, the resonance signal may have a phase shift due to the notch filters. This phase shift can increase the overall phase delay of the drive feedback, which can increase the overall complexity of a drive algorithm or circuit that generates the drive tone while also having to compensate for a phase shift when the notch filter 326 is switched in for the meter verification.

Alternatively, the stiffness value may be determined prior to the sensor signals being provided for a fluid property measurement. For example, a meter verification routine may be performed prior to a material being measured in the sensor assembly. This may not require filtering out the resonance component of the sensor signals.

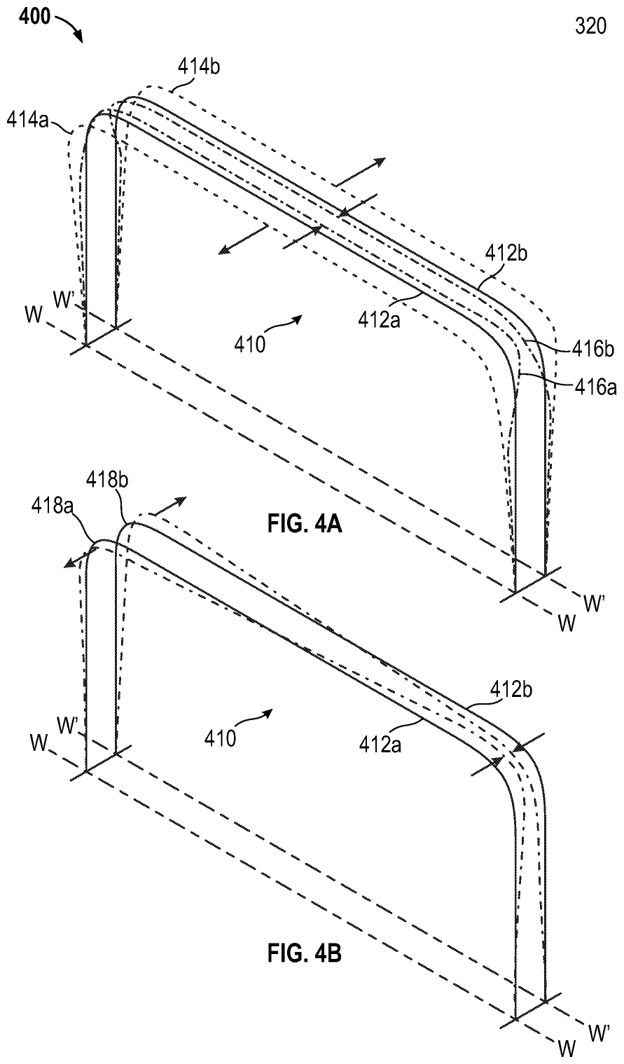

In either of the above techniques, the stiffness value may be determined using one or more vibration modes. That is, a stiffness value may be associated with a particular vibration mode or a combination of two or more vibration modes. The various vibration modes are discussed in the following with reference to FIGS. 4A and 4B.

### Vibration Modes

FIGS. 4A and 4B show wireline diagrams of conduits to illustrate vibration modes of the conduits, such as the conduits 130, 130′ described above. As shown in FIGS. 4A and 4B, the conduits are depicted by wirelines 410. The wirelines 410 have a U-shape to reflect U-shaped conduits, which may be comprised of a left conduit and a right conduit. As shown in FIGS. 4A and 4B, the wirelines 410 include a left at-rest wireline 412a and a right at-rest wireline 412b. Also shown in FIGS. 4A and 4B are bend axes W-W, W′-W′, which is collocated with a vibration node of the wirelines 410. In FIG. 4A, the wirelines 410 also include a left first order bend mode wireline 414a and a right first order bend mode wireline 414b. Also shown are a left second order bend mode wireline 416a and a right second order bend mode wireline 416b. In FIG. 4B, the wirelines 410 include a left first order twist mode 418a and a right first order twist mode 418b.

The left and right first order bend mode wirelines 414a, 414b are shown by arrows to be 180 degrees out of phase. That is, they move in an opposing manner. This may be beneficial in various ways, such as reducing a vibration of a vibratory meter due to an unbalanced displacement of the conduits. The left and right first order bend mode wirelines 414a, 414b are also shown as having a single node, which is collocated with the bend axes W-W, W-W′. The left and right second order bend mode wirelines 416a, 416b are also shown by arrows to be 180 degrees out of phase with each other. However, the left and right second order bend mode wirelines 416a, 416b have two vibration nodes, hence the term “second order.” A natural frequency of the left and right second order bend mode wirelines 416a, 416b may be higher than a natural frequency of the left and right first order bend mode wirelines 414a, 414b. The left first order twist mode 418a and the right first order twist mode 418b are shown as having asymmetric displacement relative to the left and right at-rest wirelines 412a, 412b along their respective lengths. Arrows illustrate that the left and right first order twist modes 418a, 418b are out of phase with each other.

The vibration modes illustrated by the wirelines 410 are shown as being separate but may be superimposed onto the conduits modeled by the wirelines 410. That is, the conduits modeled by the wirelines 410 may have multiple vibration modes. For example, a left conduit of the conduits may have a first order bend mode, a second order bend mode, and a twist mode. Accordingly, the conduits may have a first order out of phase bend mode, a second order out of phase bend mode, and a first order twist mode. The conduits may have additional modes, such as higher order bend modes (e.g., third, fourth, fifth, etc.), in-phase bend modes, and higher order twist modes (e.g., second, third, fourth, etc.).

As the foregoing illustrates, a vibration mode may have a shape, amplitude, and natural frequency. The shape of the vibration modes can be detected by comparing the sensor signals, such as the sensor signals 165, to each other. A phase difference between a sensor signal provided by the left pick-off sensor 1701 and a sensor signal provided by the right pick-off sensor signal 170r may indicate a twist mode excitation caused by Coriolis forces due to flow through the vibratory meter as the tubes vibrate in a bending or other mode, and may be proportional to the phase difference between the conduits 130, 130′. The amplitude of the vibration modes may be proportional to an amplitude of the sensor signals 165.

The frequencies of the vibration modes may be determined from the sensor signals 165 and/or the drive signal 185. More specifically, due to each vibration mode having a natural mode frequency, the sensor signals 165 may have components that correspond to the vibration modes of the conduits 130, 130′. Accordingly, filtering may be used to isolate the components to determine a frequency of each component. The frequency of each component corresponds to frequency of a vibration mode. The frequencies of the vibration modes may be referred to individually as a mode frequency. That is, the mode frequency is a natural frequency of a vibration mode, each of which corresponds to a component in the sensor signals 165 and/or the drive signal 185.

As mentioned above, the vibration modes may be used to determine a stiffness value. For example, the first order bend mode may be used to determine a stiffness value. A component in the sensor signal that is associated with to the first order bend mode (i.e., a bend mode response component) may be used with the corresponding non-resonance component(s) in the drive signal to determine a stiffness value. However, more than one mode may be used to determine the stiffness value.

For example, the component in the sensor signal that is associated with the first order twist mode may be used with the bend mode response component to determine a current stiffness value. This may be useful because the time delay Δt value may be affected by both modes, which is used to determine the mass flow rate \dot{m}. Therefore, compensating a mass flow rate \dot{m} measurement using, for example, a ratio of a first order bend mode stiffness and a first order twist mode stiffness may be more accurate than a mass flow rate measurement that is compensating using only the first order bend mode stiffness.

Additionally, or alternatively, a stiffness value of one of the vibration modes may be used with a frequency of another of the vibration modes to compensate a fluid measurement. For example, a stiffness value may be determined from the first order bend mode and a frequency value may be determined from the first order twist mode. This may be beneficial because determining a stiffness using the twist mode may be prohibitively expensive in terms of computation requirements, or the like.

The sensor signals provided by pickoff sensors may be provided to a mode filter to determine the first order bend mode stiffness value, the first order twist mode resonance frequency, or the like. With more particularity, the mode filter may emphasize or deemphasize sensor signals associated with a mode shape, thereby allowing a frequency, amplitude, and/or phase associated with the mode shape to be quantified. For example, the mode filter may be an average weighted filter where a LPO sensor signal is weighted by 0.5 and a RPO sensor signal is weighted by 0.5. The weighted LPO and RPO sensor signals may be summed. The resulting signal, which is an average weighted signal of the LPO and RPO sensor signals, tends to emphasize the first order out of phase bend mode because the first order out of phase bend mode induces in-phase LPO and RPO sensor signals. The resulting signal also tends to deemphasize the first order twist mode because the first order twist mode induces LPO and RPO sensor signals that are 180° out of phase.

By contrast, to emphasize the first order out of phase twist mode, one of the LPO or RPO sensor signals may be phase shifted by 180° prior to summing. By way of example, the LPO and RPO sensor signals may each be multiplied by 0.5 to provide weighted LPO and RPO sensor signals. The weighted LPO sensor signal may be phase shifted by 180°. This phase shifted and weighted LPO sensor signal may be summed with the weighted RPO sensor signal. The resulting signal, which is an average weighted signal of relative phase shifted LPO and RPO sensor signals, tends to emphasize the first order out of phase twist mode, and de-emphasize the first order out of phase bend mode, as can be appreciated.

Accordingly, to determine, for example, a twist mode frequency, the weighted average filtering of the relative phase shifted LPO and RPO sensor signals may be used to provide the average weighted signal of relative phase shifted LPO and RPO sensor signals. A frequency of the average weighted signal of relative phase shifted LPO and RPO sensor signals may be measured to determine a first order twist mode frequency. The stiffness of the first order bend mode may be determined as described above. For example, the weighted average of the LPO and RPO sensor signals may be provided to the demodulation filter 324 described with reference to FIG. 3.

As can be appreciated from the foregoing discussion, the vibration modes may have relationships. For example, a relationship between two vibration modes, herein referred to as a mode relationship, may be based on the phase, amplitude, and/or frequency of the two vibration modes, which may be characteristics of the two vibration modes. In one example, a mode relationship may be a difference between a frequency of the left and right second order bend mode wirelines 416a, 416b and a frequency of the left and right first order bend mode wirelines 414a, 414b. The mode relationship may be quantified as mode difference, ratio, or any other suitable value. For example, the mode relationship may be a difference between a time-period of the left and right second order bend mode wirelines 416a, 416b and a time-period of the left and right first order bend mode wirelines 414a, 414b.

A current stiffness value may be used alone or as part of, for example, a relationship between the first out of phase twist mode frequency and the stiffness of the first out of phase bend mode, where the current stiffness value is the stiffness of the first out of phase bend mode. That is, the current stiffness value may be part of a mode relationship, such as, a ratio, difference, or the like, between the first order twist mode frequency and the first order out of phase bend mode stiffness. The following illustrates a current stiffness value, which may be associated with the first order out of phase bend mode and may be part of, or not part of, a mode relationship, being used with a previously determined correlation between one or more stiffness values and one or more fluid property values to compensate a fluid measurement.

### Correlations Between Stiffness and Fluid Property

FIGS. 5A and 5B show graphs illustrating correlations between error values and stiffness values. As shown in FIG. 5A, the error values are mass flow rate error values and in FIG. 5B, the error values are density error values. The graphs in FIGS. 5A and 5B are respectively a mass flow rate error graph 500A and a density error graph 500B. The mass flow rate error graph 500A and the density error graph 500B include stiffness shift axes 510A, 510B and, respectively, a mass flow rate error axis 520A and a density error axis 520B, which are unit-less and expressed as percentages. Although percentages are shown, any suitable values and units may be employed, such as non-percentage values.

As shown, the stiffness shift may be of a drive mode stiffness. That is, the stiffness values may be determined using the drive mode or first order out of phase bend mode described above with reference to FIG. 4A. However, any suitable vibration mode or stiffness may be employed. Also, the percentages may be relative to values that are determined at, for example, nominal conditions, such as a nominal temperature, fluid pressure, and flange loading. The nominal conditions may be at a calibration of a vibratory meter.

For example, the stiffness shift of FIGS. 5A and 5B may be defined by Eq. [2]:

$$Stiffness Shift = \frac{( {Stiffness}_{M e a s u r e d} - {Stiffness}_{Predetermined} )}{{Stiffness}_{Predetermined}} \qquad [ 2 ]$$

In Eq. [2], Stiffness Shift is the stiffness shift, Stiffness_{Measured} is the stiffness of the vibratory meter 5 at, for example, process conditions, and Stiffness_{Predetermined} is a predetermined stiffness of the vibratory meter. The predetermined stiffness may be determined during calibration at the nominal conditions. The stiffness shift could be represented in the stiffness shift relationship by a percentage (e.g. if the result of Eq. [2] is multiplied by 100), ratio, fraction, or decimal multiple.

The mass flow rate error graph 500A and the density error graph 500B also respectively include a mass flow rate error plot 530A and a density error plot 530B that both range from about −15% to about 7% along the stiffness shift axes 510A, 510B. The mass flow rate error plot 530A ranges from about 15% to −6% along the mass flow rate error axis 520A. The density error plot 530B ranges from about 0.9% to about −0.4% along the density error axis 520B. However, any suitable ranges, units, and ratios for other fluid property axes may be employed. The mass flow rate error plot 530A and the density error plot 530B may be determined by linear interpolation of mass flow rate error values and density error values that are determined relative to various stiffness values, which, as shown are stiffness shift values. That is, the mass flow rate error plot 530A and the density error plot 530B are correlations between fluid property values and stiffness values of a sensor assembly.

The correlations between the fluid property values and the stiffness values may be a stiffness-to-fluid property relationship, such as, for example, a linear relationship. For instance, the correlations between the fluid property values and the stiffness values may be represented by a linear relationship having a slope and intercept, where the linear relationship is between the fluid property values and stiffness values. For instance, the linear relationship may be described by Eq. [3]:

Error_{FM}=A*Stiffness Shift+B, [3]

where Error_{FM} is a fluid property error (e.g., mass flowrate error, density error, or viscosity), A is a constant slope of the linear relationship, Stiffness Shift is the stiffness shift. The Stiffness Shift may be determined using Eq. [2], and B is a constant intercept of the relationship. In an embodiment, the fluid property error may be represented by a percentage (e.g., if the result of Eq. [3] is multiplied by 100), ratio, fraction, or decimal, for instance.

As shown in FIGS. 5A and 5B, fluid property measurements are illustrated by mass flow rate error values 540A and density error values 540B, which are shown as discrete plots. The mass flow rate error values 540A and the density error values 540B may be determined by, for example, simulating via finite element method (FEM) that simulates the effect of varying a temperature, pressure, and/or flange loading of a sensor assembly. The mass flow rate error values 540A and density error values 540B may also be determined by empirical methods where stiffness values are measured contemporaneously to mass flow rate and density measurements.

The mass flow rate error values 540A and the density error values 540B may respectively be relative to nominal mass flow rate values and density values. That is, mass flow rate values and density values determined under varied process conditions that cause a stiffness of a sensor assembly to change. The mass flow rate error values 540A and the density error values 540B may be determined by subtracting the mass flow rate values and density values determined at nominal conditions by the mass flow rate values and density values determined at nominal conditions and respectively dividing the results by the mass flow rate values and density values determined at nominal conditions.

As discussed above, there is a linear relationship between the mass flow rate error values 540A and density error values 540B and their corresponding stiffness values. The mass flow rate error plot 530A and the density error plot 530B may respectively be generated by linear interpolation from the mass flow rate error values 540A and the density error values 540B. However, any suitable plot may be generated by any suitable means, such as, for example, extrapolation, using non-linear fits, etc.

As can be appreciated from the above discussion, a stiffness value may be correlated to a fluid property value regardless of what causes the stiffness of the vibratory meter to change. As a result, a fluid property measurement may be compensated regardless of the process condition or conditions that may cause the fluid property measurement to be inaccurate, as is discussed in more detail in the following.

The mass flow rate error plot 530A, density error plot 530B, mass flow rate error values 540A, and density error values MOB may be previously determined correlations between one or more stiffness values of the sensor assembly and corresponding one or more fluid property values. For example, a table that relates the mass flow rate error values 540A to stiffness values may be stored in, for example, the meter electronics 20 described above. Similarly, a table that relates density error values 540B to corresponding stiffness values may be stored in the meter electronics 20 described above. Additionally or alternatively, the mass flow rate error plot 530A and the density error plot 530B may be stored in the meter electronics in, for example, equation form that can be used to determine a mass flow rate error value or a density error value from a current stiffness value.

Accordingly, when a process material is subsequently measured by a sensor assembly and the current stiffness value of the sensor assembly is also determined, then the mass flow rate measurement and/or the density measurement may be compensated by using the correlations. For example, the current stiffness value may be input into the equation expressing the mass flow rate error plot 530A to determine a corresponding mass flow rate error value, which can be used to compensate a mass flow rate value determined from the sensor signals provided by the sensor assembly.

Accordingly, the mass flow rate error plot 530A, density error plot 530B, mass flow rate error values 540A, and density error values 540B correlate one or more stiffness values to fluid property correction values. As described above, the fluid property correction values are percentage error values. That is, the fluid property correction values are expressed as errors relative to a nominal value. The percentage error values are mass flow rate error values and density error values, which may be determined directly from the mass flow rate error values 540A and density error values 540B, or indirectly by interpolation, such as the mass flow rate error plot 530A and density error plot 530B.

The current stiffness value can be determined contemporaneous to the fluid property measurement or may be previously determined. That is, the current stiffness value may be determined from the same sensor signals as the fluid property measurement or may be determined prior to the fluid property measurement. In the latter scenario, the current stiffness value may be determined from sensor signals while the sensor assembly is subject to known process conditions, such as temperature, pressure, and flange loading. These values may, for example, be assumed to be the same when the fluid property is measured. For example, the temperature, pressure, and/or flange loading may be assumed to be constant throughout a series of fluid property measurements.

The mass flow rate error plot 530A, density error plot 530B, mass flow rate error values 540A, and/or density error values 540B may be correlations between previously determined stiffness values and fluid property correction values. For example, the current stiffness value may be correlated to a mass flow rate error value of the mass flow rate error plot 530A by comparing the current stiffness value with the previously determined stiffness value of the mass flow rate error plot 530A, and determining a corresponding mass flow rate error value. The mass flow rate error value may be used as the fluid property correction value to correct a mass flow rate value calculated according to the above equation [1]. Similar corrections may be made using the density error plot 530B. These and other values may be stored in the meter electronics 20 for compensating a fluid measurement, as is described in more detail in the following.

### Meter Electronics for Compensating a Fluid Property Measurement

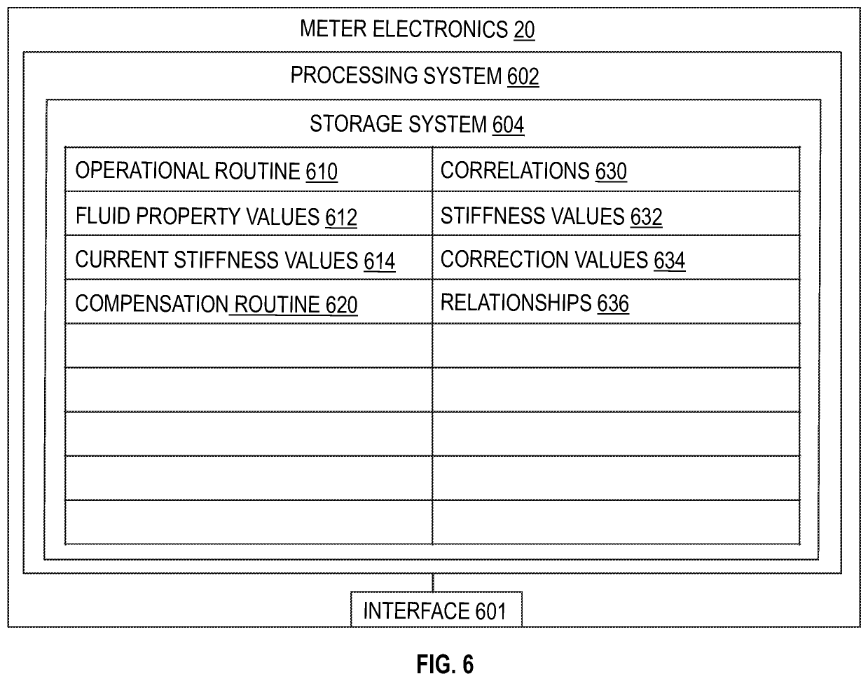

FIG. 6 shows the meter electronics 20 for compensating a fluid property measurement. As shown in FIG. 4, the meter electronics 20 includes an interface 601 and a processing system 602. The meter electronics 20 receives a vibrational response, such as from the sensor assembly 10, for example. The meter electronics 20 processes the vibrational response in order to obtain flow characteristics of the flow material flowing through the sensor assembly 10.

The interface 601 may receive the sensor signals 165 from one of the pick-off sensors 1701, 170r shown in FIGS. 1 and 2. The interface 601 can perform any necessary or desired signal conditioning, such as any manner of formatting, amplification, buffering, etc. Alternatively, some or all of the signal conditioning can be performed in the processing system 602. In addition, the interface 601 can enable communications between the meter electronics 20 and external devices. The interface 601 can be capable of any manner of electronic, optical, or wireless communication. The interface 601 can provide information based on the vibrational response. The interface 601 may be coupled with a digitizer, such as the CODEC 222 shown in FIG. 2, wherein the sensor signal comprises an analog sensor signal. The digitizer samples and digitizes an analog sensor signal and produces a digitized sensor signal.

The processing system 602 conducts operations of the meter electronics 20 and processes flow measurements from the sensor assembly 10. The processing system 602 executes one or more processing routines and thereby processes the flow measurements in order to produce one or more flow characteristics. The processing system 602 is communicatively coupled to the interface 601 and is configured to receive the information from the interface 601.

The processing system 602 can comprise a general-purpose computer, a micro-processing system, a logic circuit, or some other general purpose or customized processing device. Additionally, or alternatively, the processing system 602 can be distributed among multiple processing devices. The processing system 602 can also include any manner of integral or independent electronic storage medium, such as the storage system 604.

The storage system 604 can store flow meter parameters and data, software routines, constant values, and variable values. In one embodiment, the storage system 604 includes routines that are executed by the processing system 602, such as the operational routine 610 and compensation routine 620 of the vibratory meter 5. The storage system can also store statistical values, such as a standard deviation, confidence intervals, or the like.

The operational routine 610 may perform functions necessary to measure fluid properties of a fluid and determine current stiffness values of the sensor assembly, such as the sensor assembly 10 described above. For example, the operational routine 610 may determine a time delay between an LPO sensor signal and RPO sensor signal, measure a frequency of the LPO or RPO sensor signals, or the like.

Accordingly, the operational routine 610 may determine a fluid property value 612, such as a time delay or phase difference, a resonance frequency, etc. The fluid property value may also be a mass flow rate value, density value, etc. The operational routine 610 may store the fluid property value in the fluid property values 612. The operational routine 610 may also determine a current stiffness value 614 of the sensor assembly. For example, the operational routine 610 may contemporaneously determine the current stiffness value 614 and the fluid property values 612 as described above with reference to FIG. 3.

The compensation routine 620 may correct the fluid property value, such as a mass flow rate value, by, for example, determining a mass flow rate error value from a current stiffness value. That is, the mass flow rate error value may be a fluid property correction value. Other correction values may be employed and may have units, rather percentage error values. Accordingly, the compensation routine 620 may use a correlation between a fluid property correction value and the current stiffness value to correct a fluid property value. By way of example, a mass flow rate value may be corrected by adjusting the mass flow rate value using the mass flow rate error value.

The processing system 602 may accordingly store correlations 630. As shown in FIG. 6, the correlations 630 include stiffness values 632, correction values 634, and relationships 636. The correlations 630 may correlate the stiffness values 632 and the correction values 634 in any suitable manner. The current stiffness value may be correlated with a fluid property correction value stored or determined from the correction values 634 by using a stiffness value of or determined from the stiffness values 632. Accordingly, the stiffness values 632 may be predetermined stiffness values. The stiffness values 632 may be part of a mode relationship, such as, for example, a relationship between a stiffness of a first order twist mode and a frequency of a first order bend mode. The current stiffness value may be correlated with the fluid property correction value by using, for example, a previously determined stiffness-to-fluid property relationship in the relationships 636. An exemplary stiffness-to-fluid property relationship may be the stiffness shift-to-fluid property error of equation [3] discussed above, although any suitable stiffness-to-fluid property relationship may be employed.

### Method

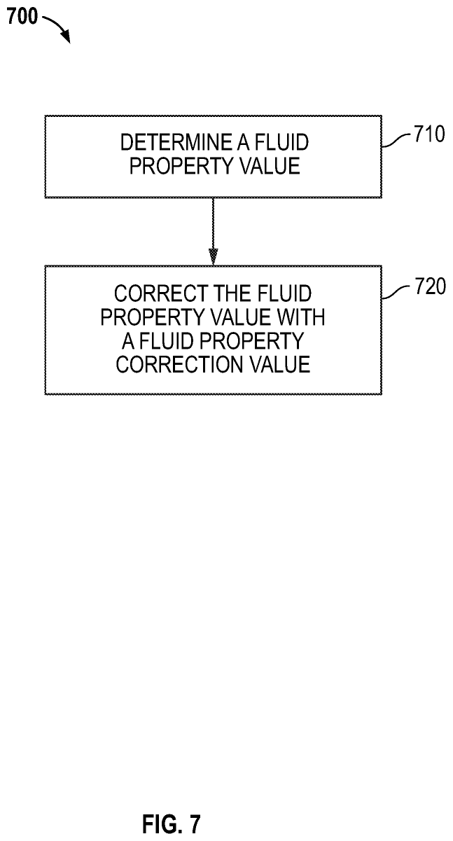

FIG. 7 shows a method 700 for using a stiffness measurement to compensate a fluid property measurement. As shown in FIG. 7, the method 700 beings by determining a fluid property value based on sensor signals in step 710. The sensor signals may be provided by the sensor assembly 10 described above, although any suitable sensor assembly may be employed. The fluid property value may be a mass flow rate value, a density value, a time delay or phase difference, a resonance frequency of the sensor assembly, or the like. In step 720, the method 700 corrects the fluid property value with a fluid property correction value. The fluid property correction value may be correlated with a current stiffness value of the sensor assembly.

The method 700 may also determine the current stiffness value of the sensor assembly. That is, the method 700 may use, for example, the sensor signals provided by the sensor assembly and determine the current stiffness value. The current stiffness value may be part of a mode relationship. Additionally, or alternatively, the method 700 may determine the current stiffness value by obtaining a stored current stiffness value that was determined and stored prior to the fluid property value being determined, but nevertheless, is an accurate measurement of the stiffness of the sensor assembly. For example, shortly before a fluid is measured to determine the fluid property value, the current stiffness value may be determined by determining the stiffness value of the sensor assembly under process conditions. Subsequently, the process conditions, such as temperature, pressure, or the like, may remain constant thereby ensuring the current stiffness value is accurate.

The method 700 may also use the previously determined stiffness value of the sensor assembly to correlate the current stiffness value with the fluid property correction value. For example, the method 700 may read or calculate the previously determined stiffness value and a fluid property correction value from the stiffness values 632 and correction values 634. The previously determined stiffness value and the fluid property correction value may be correlated, such as, for example, as described above with reference to FIGS. 5A and 5B. The current stiffness value may be compared to the previously determined stiffness value to determine if the fluid property correction value can be used to correct the fluid property value. For example, the current stiffness value is within a range of the previously determined stiffness value, the fluid property correction value correlated with the previously determined stiffness value may be used. Accordingly, the current stiffness value may be correlated with the fluid property correction value.

As discussed above, the previously determined stiffness value of the sensor assembly, the fluid property correction value, and the correlation between the previously determined stiffness value and the fluid property correction value may be determined by using empirical analysis or computer model of a sensor assembly that is the same as the sensor assembly providing the sensor signals in step 710, a similar sensor assembly having the same or similar design, etc. The current stiffness value is determined for the sensor assembly that measures the fluid to determine the fluid property value to be corrected. The correlation between the previously determined stiffness value and the fluid property correction value may be by a table of values, equation, etc.

The vibratory meter 5, meter electronics 20, and method 700 described above may use the stiffness measurement to compensate a fluid property measurement. Accordingly, few sensors may be employed, such as temperature sensors, pressure sensors or the like. More specifically, because the current stiffness value of the sensor assembly depends on the temperature of the sensor assembly, the pressure of the fluid being measured by the sensor assembly, and the like, the current stiffness value may correct the fluid property value without using temperature values, pressure values, or other non-stiffness values, of the fluid and/or sensor assembly.

In addition, because the current stiffness value is dependent on various process conditions, a single correlation between the previously determined stiffness value and the fluid property correction value may be employed. That is, instead of multiple correlations between temperatures, pressures, and other process conditions, and the fluid property correction value, only one correlation may be needed. This can simplify and reduce the computations required to compensate the fluid property measurement. Accordingly, the processing system 602 may operate more efficiently and devote more computing resources to other tasks thereby improving the functions of the processing system 602.

Further, correcting the fluid property value with the current stiffness value may also be more accurate than those that use temperature and/or pressure sensors. For example, the current stiffness value may be dependent on flange loading that is applied to the sensor assembly. The flange loading may not be accurately measured and may vary significantly over time. Because the current stiffness value is dependent on the flange loading, the correlation between the current stiffness value and the fluid property correction value may be more accurate than, for example, an estimate of the flange loading and a correlation of the estimate to the fluid property correction value. The operation of the vibratory meter 5 is therefore improved by providing a more accurate fluid property measurement.

The detailed descriptions of the above embodiments are not exhaustive descriptions of all embodiments contemplated by the inventors to be within the scope of the present description. Indeed, persons skilled in the art will recognize that certain elements of the above-described embodiments may variously be combined or eliminated to create further embodiments, and such further embodiments fall within the scope and teachings of the present description. It will also be apparent to those of ordinary skill in the art that the above-described embodiments may be combined in whole or in part to create additional embodiments within the scope and teachings of the present description.

Thus, although specific embodiments are described herein for illustrative purposes, various equivalent modifications are possible within the scope of the present description, as those skilled in the relevant art will recognize. The teachings provided herein can be applied to other meter electronics, vibratory meters, and methods for using a stiffness measurement to compensate a fluid property measurement and not just to the embodiments described above and shown in the accompanying figures. Accordingly, the scope of the embodiments described above should be determined from the following claims.

We claim:

1. A meter electronics (20) for using a stiffness measurement to compensate a fluid property measurement, the meter electronics (20) comprising:
an interface (601) configured to communicatively couple to a sensor assembly (10) and receive sensor signals from the sensor assembly (10); and
a processing system (602) communicatively coupled to the interface (601), the processing system (602) being configured to:
determine a fluid property value based on the sensor signals; and
correct the fluid property value with a fluid property correction value, the fluid property correction value being correlated with a current stiffness value of the sensor assembly.

2. The meter electronics (20) of claim 1, wherein the processing system (602) is further configured to determine the current stiffness value of the sensor assembly (10).

3. The meter electronics (20) of claim 1, wherein the processing system (602) is further configured to use a previously determined stiffness value of the sensor assembly to correlate the current stiffness value with the fluid property correction value.

4. The meter electronics (20) of claim 3, wherein the previously determined stiffness value is correlated with the fluid property correction value.

5. The meter electronics (20) of claim 4, wherein the previously determined stiffness value is correlated with the fluid property correction value by using at least one of an empirical analysis and a computer model of the sensor assembly.

6. The meter electronics (20) of claim 1, wherein the fluid property correction value is correlated with the current stiffness value by using a previously determined stiffness-to-fluid property relationship.

7. The meter electronics (20) of claim 1, wherein the fluid property value is one of a mass flow rate value, a density value, a time delay value, a phase difference value, a resonance frequency value, and an oscillation period value.

8. The meter electronics (20) of claim 1, wherein the fluid property correction value is a percentage error value.

9. The meter electronics (20) of claim 1, wherein the current stiffness value is part of a mode relationship, the mode relationship being a relationship between characteristics of two vibration modes.

10. A method of using a stiffness measurement to compensate a fluid property measurement, the method comprising:
determining a fluid property value of a fluid based on sensor signals provided by a sensor assembly containing the fluid; and
correcting the fluid property value with a fluid property correction value, the fluid property correction value being correlated with a current stiffness value of the sensor assembly.

11. The method of claim 10, further comprising determining the current stiffness value of the sensor assembly.

12. The method of claim 10, further comprising using a previously determined stiffness value of the sensor assembly to correlate the current stiffness value with the fluid property correction value.

13. The method of claim 12, wherein the previously determined stiffness value is correlated with the fluid property correction value.

14. The method of claim 13, wherein the previously determined stiffness value is correlated with the fluid property correction value by using at least one of an empirical analysis and a computer model of the sensor assembly.

15. The method of claim 10, further comprising correlating the fluid property correction value with the current stiffness value by using a previously determined stiffness-to-fluid property relationship.

16. The method of claim 10, wherein the fluid property value is one of a mass flow rate value, a density value, a time delay value, a phase difference value, a resonance frequency value, and an oscillation period value.

17. The method of claim 10, wherein the fluid property correction value is a percentage error value.

18. The method of claim 10, wherein the current stiffness value is part of a mode relationship, the mode relationship being a relationship between characteristics of two vibration modes.
